(19) United States
(12) Patent Application Publication
(10) Pub. No.: US 2013/0317909 A1
(43) Pub. Date: Nov. 28, 2013

(54) PUBLICITY DISPLAY DEVICE, PUBLICITY DISPLAY METHOD, PUBLICITY DISPLAY PROGRAM, AND COMPUTER-READABLE RECORDING MEDIUM WHICH STORES SAID PROGRAM

(71) Applicants: Shigaku Iwabuchi, Chiyoda-ku (JP); Soh Masuko, Shinagawa-ku (JP); Jiro Tanaka, Tsukuba-shi (JP); Yuichi Murata, Tsukuba-shi (JP)

(72) Inventors: Shigaku Iwabuchi, Chiyoda-ku (JP); Soh Masuko, Shinagawa-ku (JP); Jiro Tanaka, Tsukuba-shi (JP); Yuichi Murata, Tsukuba-shi (JP)

(73) Assignee: RAKUTEN, INC., Shinagawa-ku, Tokyo (JP)

(21) Appl. No.: 13/984,146

(22) PCT Filed: Jun. 13, 2011
(86) PCT No.: PCT/JP2011/063527

§ 371 Date: Aug. 7, 2013

(30) Foreign Application Priority Data
Mar. 8, 2011 (JP) 2011-050468

(51) Int. Cl. G06Q 30/02

(52) U.S. Cl. CPC G06Q 30/0255
USPC 705/14.53

(57) ABSTRACT

An advertisement server (10) includes an associate extraction unit (12) for, in order to specify an associate user in a specified human relationship with a reference user, extracting an associate user ID of the associate user corresponding to a reference user ID indicating the reference user from a user relationship database (21) that stores relationship data indicating relationships between users, a comment extraction unit (13) for extracting comment data corresponding to the associate user ID from a comment database (22) that stores comment data indicating comments on items by users, a generation unit (16) for generating advertisement content of an item indicated by the comment data, the advertisement content displaying a comment indicated by the extracted comment data, and a transmitting unit (17) for outputting the advertisement content so that the generated advertisement content is displayed on a given screen.

### TECHNICAL FIELD

One embodiment of the present invention relates to an advertisement display device, an advertisement display method, an advertisement display program, and a computer-readable recording medium storing the program.

### BACKGROUND ART

With the widespread of computers and the Internet, various advertisements such as banner advertisements, keyword targeted advertisements and e-mail magazines are widely used. For example, a communication system that displays an advertisement in on-line chat or message sending and thereby creates a new advertising space is disclosed in Patent Literature 1 below. In this system, a server device that processes dialogue data between a plurality of users and a client device of each user are connected to each other. The server device includes a chat processing unit or a message processing unit that enables output of advertisement data for showing an advertisement to a user together with dialogue data to the user through the client device and a communication control interface that transmits the advertisement data and the dialogue data to the client device.

### CITATION LIST

### Patent Literature

PTL 1: JP 2002-123477 A

### SUMMARY OF INVENTION

### Technical Problem

With such a background, there is a demand for an advertisement that effectively attracts the interest of consumers and promotes consumer buying behavior.

Accordingly, an object of one aspect of the present invention is to present an advertisement that effectively attracts the interest of consumers.

### Solution to Problem

An advertisement display device according to one aspect of the invention includes an associate extraction means for, in order to specify an associate user in a specified human relationship with a reference user, extracting an associate user ID of the associate user corresponding to a reference user ID indicating the reference user from a user relationship database that stores relationship data indicating relationships between users, a comment extraction means for extracting comment data corresponding to the associate user ID extracted by the associate extraction means from a comment database that stores comment data indicating comments on items by users, a generation means for generating advertisement content of an item indicated by the comment data extracted by the comment extraction means, the advertisement content displaying a comment indicated by the comment data, and an output means for outputting the advertisement content generated by the generation means so that the advertisement content is displayed on a given screen.

An advertisement display method according to one aspect of the invention is an advertisement display method executed by an advertisement display device, the method including an associate extraction step of, in order to specify an associate user in a specified human relationship with a reference user, extracting an associate user ID of the associate user corresponding to a reference user ID indicating the reference user from a user relationship database that stores relationship data indicating relationships between users, a comment extraction step of extracting comment data corresponding to the associate user ID extracted in the associate extraction step from a comment database that stores comment data indicating comments on items by users, a generation step of generating advertisement content of an item indicated by the comment data extracted in the comment extraction step, the advertisement content displaying a comment indicated by the comment data, and an output step of outputting the advertisement content generated in the generation step so that the advertisement content is displayed on a given screen.

An advertisement display program according to one aspect of the invention causes a computer to function as an associate extraction means for, in order to specify an associate user in a specified human relationship with a reference user, extracting an associate user ID of the associate user corresponding to a reference user ID indicating the reference user from a user relationship database that stores relationship data indicating relationships between users, a comment extraction means for extracting comment data corresponding to the associate user ID extracted by the associate extraction means from a comment database that stores comment data indicating comments on items by users, a generation means for generating advertisement content of an item indicated by the comment data extracted by the comment extraction means, the advertisement content displaying a comment indicated by the comment data, and an output means for outputting the advertisement content generated by the generation means so that the advertisement content is displayed on a given screen.

A computer-readable recording medium according to one aspect of the invention stores an advertisement display program that causes a computer to function as an associate extraction means for, in order to specify an associate user in a specified human relationship with a reference user, extracting an associate user ID of the associate user corresponding to a reference user ID indicating the reference user from a user relationship database that stores relationship data indicating relationships between users, a comment extraction means for extracting comment data corresponding to the associate user ID extracted by the associate extraction means from a comment database that stores comment data indicating comments on items by users, a generation means for generating advertisement content of an item indicated by the comment data extracted by the comment extraction means, the advertisement content displaying a comment indicated by the comment data, and an output means for outputting the advertisement content generated by the generation means so that the advertisement content is displayed on a given screen.

In the above aspects, an associate user in a specified human relationship with a reference user is specified, and a comment on an item by the associate user is extracted. Then, the content of an item advertisement in which the comment is displayed is generated and finally displayed on a given screen. In this manner, by displaying an item advertisement including a comment of a person who is in some kind of relationship, not a total stranger, a user who views the advertisement can see the comment as being familiar. As a result, it is possible to effectively attract the interest of the user (consumer).

In the advertisement display device according to another aspect, the associate extraction means may extract user IDs of a specified number of users extracted sequentially in ascending order of the number of hops from the reference user indicated by the relationship data as the associate user ID.

In this case, because a comment of a person who is in a close relationship with the reference user is displayed included in an item advertisement, a user who views the advertisement can see the comment as being familiar. As a result, it is possible to effectively attract the interest of the user (consumer).

In the advertisement display device according to another aspect, the reference user may be a viewer of the screen, and the associate extraction means may specify a user where a distance from the viewer is a specified number of hops by referring to the user relationship database, specify an item on which a comment has been made by the specified user by referring to the comment database, and extract user IDs of a specified number of users extracted sequentially in ascending order of the number of hops from the viewer among users who have made comments on the item as the associate user ID.

In this case, a user who is in a close relationship with a viewer is specified, and a specified number of users who are in a close relationship with the viewer among users who have made comments on an item on which the specified user has made a comment are extracted. Accordingly, comments by the users who are in a close relationship with the viewer are displayed as a part of the advertisement content. As a result, the viewer can see the comments as being familiar, and it is thereby possible to let the viewer (consumer) have a further interest in the item.

In the advertisement display device according to another aspect, the reference user may be a creator who set up a web page displayed on the screen, and the associate extraction means may specify an item on which a comment has been made by the creator by referring to the user relationship database, and extract user IDs of a specified number of users extracted sequentially in ascending order of the number of hops from the creator among users who have made comments on the item as the associate user ID.

In this case, among users who have made comments on an item on which a creator who set up an accessed web page has made a comment, a specified number of users who are in a close relationship with the creator are extracted. Consequently, comments on the item which the creator has got interested in by users who are in a close relationship with the creator are displayed as a part of the advertisement content. As a result, the viewer can see the comments by the creator who set up the web page which the viewer got interested in or persons close to that creator as being familiar. It is thereby possible to let the viewer (consumer) have a further interest in the item.

In the advertisement display device according to another aspect, the reference user may include a creator who set up a web page displayed on the screen and a viewer of the screen, and the associate extraction means may extract user IDs of a specified number of users extracted sequentially in ascending order of the number of hops from the creator and the viewer among users who have made comments on the specified item as the associate user ID.

In this case, among users who have made comments on an item on which a creator who set up an accessed web page has made a comment, a specified number of users who are in a close relationship with both of the creator and the viewer are extracted. Consequently, comments on the item which the creator has got interested in by users who are in a close relationship with the creator and the viewer are displayed as a part of the advertisement content. As a result, the viewer can see the comments by not only the creator but also those who are close to the viewer as being familiar. It is thereby possible to let the viewer (consumer) have a further interest in the item.

In the advertisement display device according to another aspect, the generation means may generate the advertisement content so that the comments are displayed in order of registration of the comments.

In this manner, by displaying comments in order of registration, which is, in chronological order, it is possible to give a visual effect as if a conversation is made to the viewer. It is thereby possible to effectively attract the interest of the user (consumer).

### Advantageous Effects of Invention

According to one aspect of the present invention, because a comment of a person who is in some kind of relationship with a user, not a total stranger to the user, is displayed included in an item advertisement, it is possible to effectively attract the interest of the user (consumer).

### BRIEF DESCRIPTION OF DRAWINGS

FIG. 1 is a diagram showing an overall configuration of an advertisement display system.

FIG. 2 is a block diagram showing a functional configuration of an advertisement server according to a first embodiment.

FIG. 3 is a block diagram showing a hardware configuration of the advertisement server shown in FIG. 2.

FIG. 4 is a diagram showing an example of a user relationship database shown in FIG. 2

FIG. 5 is a diagram showing an example of a comment database shown in FIG. 2.

FIG. 6 is a diagram showing another example of a comment database shown in FIG. 2.

FIG. 7 is a diagram showing an example of a banner advertisement.

FIG. 8 is a diagram showing another example of a banner advertisement.

FIG. 9 is a sequence chart showing an operation of the advertisement display system (particularly, the advertisement server).

FIG. 10 is a flowchart showing details of an associate user ID extraction process shown in FIG. 9.

FIG. 11 is a flowchart showing details of a comment data extraction process shown in FIG. 9.

FIG. 12 is a flowchart showing details of a material data extraction process shown in FIG. 9.

FIG. 13 is a flowchart showing details of a banner advertisement generation process shown in FIG. 9.

FIG. 14 is a block diagram showing a configuration of an advertisement display program according to the first embodiment.

FIG. 15 is a block diagram showing a functional configuration of an advertisement server according to a second embodiment.

FIG. 16 is a flowchart showing an associate user ID extraction process in the advertisement server shown in FIG. 15.

FIG. 17 is a block diagram showing a functional configuration of an advertisement server according to a third embodiment.

FIG. 18 is a flowchart showing an associate user ID extraction process in the advertisement server shown in FIG. 17.

FIG. 19 is a diagram showing an example of a user ID translation table according to an alternative example.

### DESCRIPTION OF EMBODIMENTS

Embodiments of the present invention are described hereinafter in detail with reference to the appended drawings. In the description of the drawings, the same or equivalent elements are denoted by the same reference symbols, and the redundant explanation thereof is omitted.

### First Embodiment

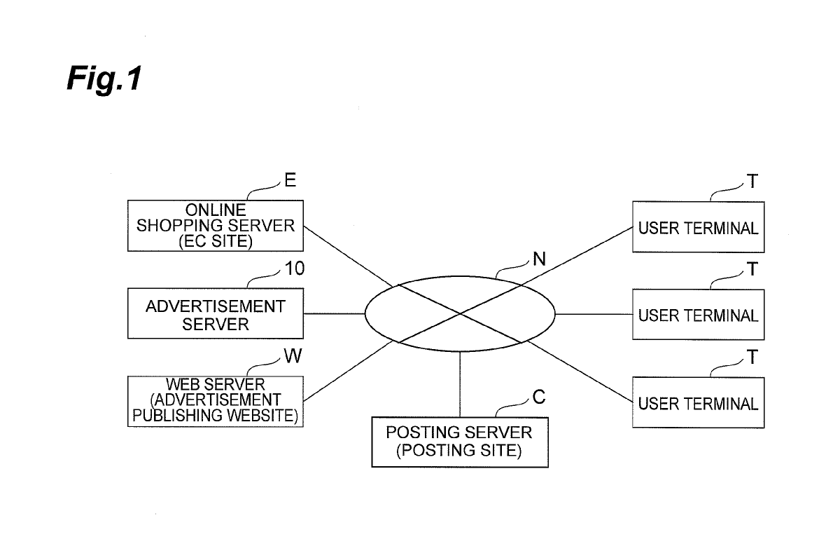

The functions and configuration of an advertisement server 10 according to a first embodiment are described firstly with reference to FIGS. 1 to 8. The advertisement server 10 is an advertisement display device that generates and outputs a banner advertisement to be displayed at a specified position in a web page that is viewed by a user. As shown in FIG. 1, the advertisement server 10 can communicate with an online shopping server E, a web server W, a posting server C, and a plurality of user terminals T through a communication network N. Those servers and terminals constitute an advertisement display system.

The online shopping server E is a computer that provides a web page (EC site) of a virtual shopping mall to a terminal user. The web server W is a computer that provides a web page to a user terminal T in response to a request from the user terminal T. Further, the web server W provides a banner advertisement to be displayed on the web page to the user terminal T. Accordingly, the web page that is provided from the web server W shows an advertisement publishing website. The banner advertisement is generated in the advertisement server 10. The posting server C is a computer that provides a web page (so-called posting site) that accepts comments on items as a part of a social networking service (SNS) to a terminal user and stores comments received from user terminals T through this site.

Note that an item to be shown on the banner advertisement is not limited to a specific kind. The item is not limited to a tangible object and may be a non-tangible object such as a service.

The user terminal T is a computer having the function of a web browser. Examples of the user terminal T include an advanced mobile phone (smart phones), a personal digital assistant (PDA), various kinds of personal computers (tablet PC, desktop computer, notebook computer etc.) and the like, though the variety of the user terminal T is not limited thereto. Although three user terminals T are shown in FIG. 1, the number of user terminals T is not particularly limited.

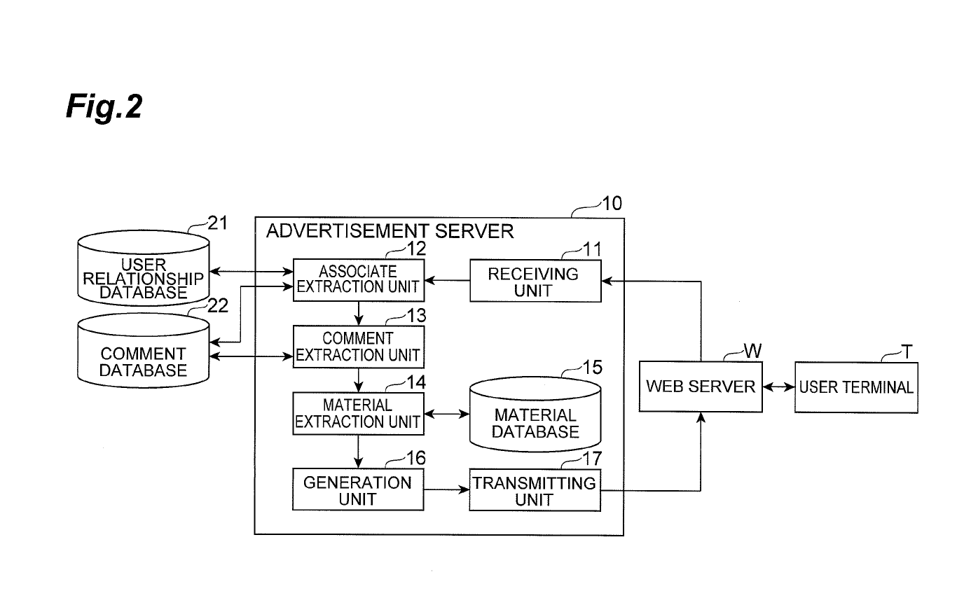

As shown in FIG. 2, the advertisement server 10 includes a receiving unit 11, an associate extraction unit (associate extraction means) 12, a comment extraction unit (comment extraction means) 13, a material extraction unit 14, a material database 15, a generation unit (generation means) 16, and a transmitting unit (output means) 17 as functional components.

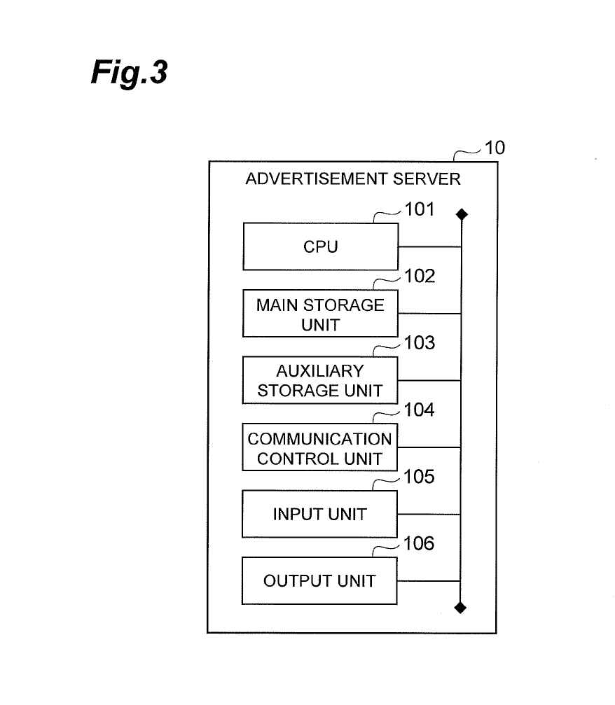

As shown in FIG. 3, the advertisement server 10 is composed of a CPU 101 that executes an operating system, an application program and the like, a main storage unit 102 such as ROM and RAM, an auxiliary storage unit 103 such as a hard disk, a communication control unit 104 such as a network card, an input unit 105 such as a keyboard and a mouse, and an output unit 106 such as a monitor. The functions of the advertisement server 10 are implemented by loading given software onto the CPU 101 or the main storage unit 102, making the communication control unit 104, the input unit 105, the output unit 106 and the like operate under control of the CPU 101, and performing reading and writing of data in the main storage unit 102 or the auxiliary storage unit 103. The data and database required for processing are stored in the main storage unit 102 or the auxiliary storage unit 103.

Note that, although the advertisement server 10 is composed of one computer in the example of FIG. 3, the functions of the server may be distributed among a plurality of computers. For example, the advertisement server 10 may be composed of a computer that includes the material database 15 and a computer that includes the other functional components.

The advertisement server 10 refers to databases (external databases) that reside outside the server at the time of generating a banner advertisement. Thus, prior to describing the components of the advertisement server 10, several external databases are described. Specifically, a user relationship database 21 and a comment database 22 are described hereinbelow.

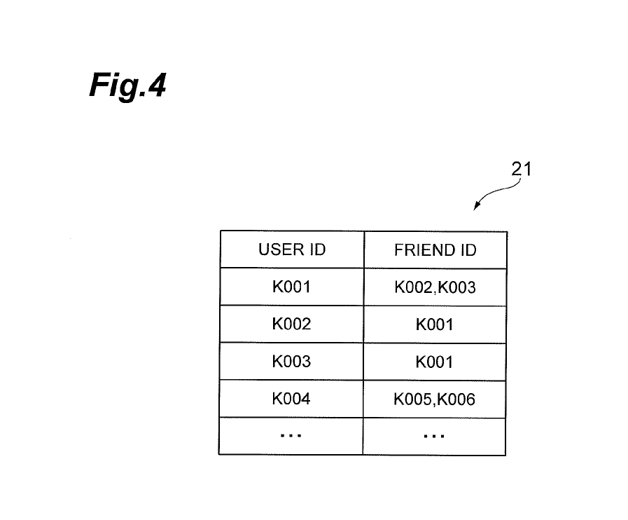

The user relationship database 21 is a means of storing relationship data indicating the relationship between users. Although the user relationship database 21 resides in the posting server C in this embodiment, the database may reside in any place. As shown in FIG. 4, the relationship data is data in which a user ID as a reference and ID (friend ID) of a user who is in the relationship of friends with a user specified by the user ID in SNS are associated with each other. The data in the first to third rows in FIG. 4 shows that the user specified by the user ID “K001” is in a two-way friend relationship with two users specified by the user IDs “K002” and “K003”. The friend relationship, however, may be one way. For example, in the case where the data of the second and third rows in FIG. 4 does not exist, while the user specified by the user ID “K001” has a friend relationship with the two users specified by the user IDs “K002” and “K003”, when viewed from the two users, the user specified by the user ID “K001” is a stranger to them.

The comment database 22 is a means of storing comment data indicating comments on items by users. Although the comment database 22 resides in at least one of the posting server C and the online shopping server E in this embodiment, the database may also reside in any place. There may be several configurations of the comment database 22 and the comment data.

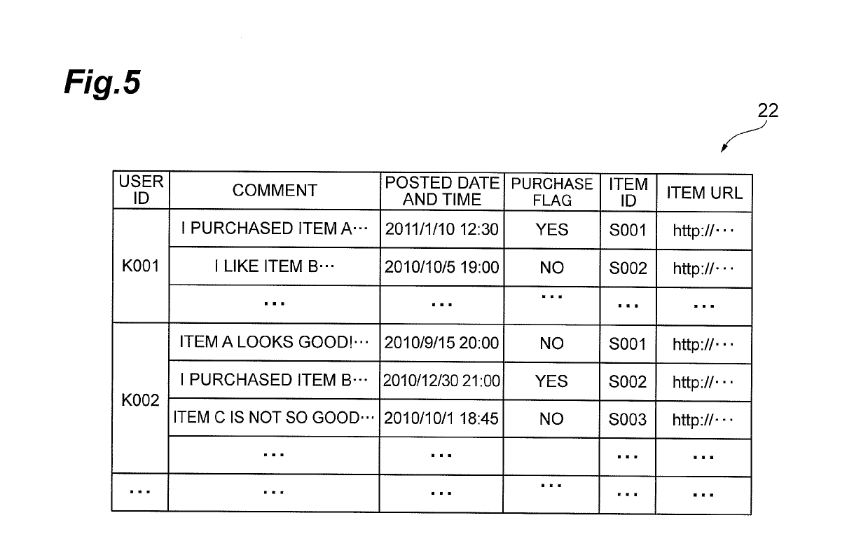

In the example of FIG. 5, the comment data is data in which a user ID indicating a person who posted a comment, the comment, date and time when the comment was posted, a purchase flag indicating whether the person has purchased the item on which the comment was made, an item ID that identifies the item, and the URL (item URL) of a web page on which the item appears are associated with one another. For example, the comment data in the first row shows that the user identified by the user ID “K001” has purchased the item A specified by the item ID “S001” and made a comment on the item A.

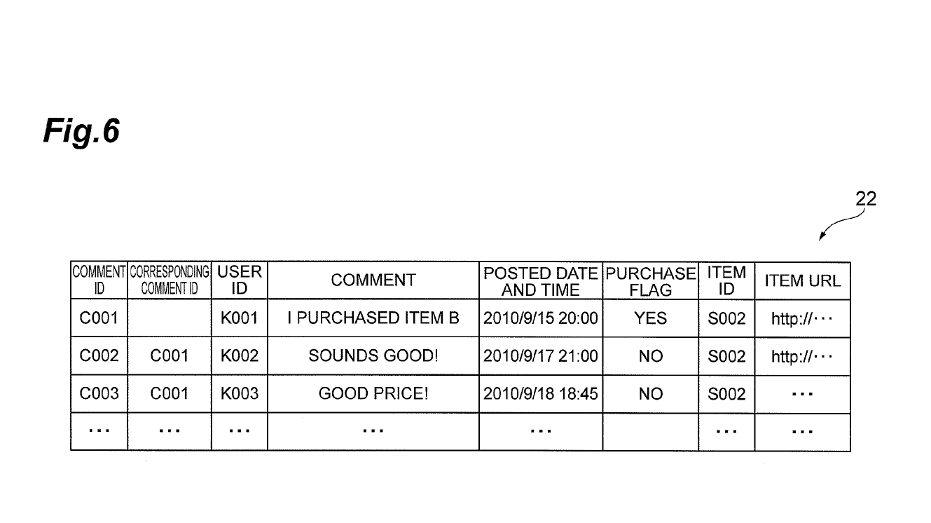

In the example of FIG. 6, the comment data is data in which a comment ID that uniquely identifies a comment, a corresponding comment ID indicating to which comment a reply is made, a user ID, a comment, posted data and time, a purchase flag, an item ID and an item URL are associated with one another. The example of FIG. 6 shows the case where, for the comment “I purchased the item B” by a user with the user ID “K001”, a user with the user ID “K002” has made a comment (reply) “Sounds good”, and a user with the user ID “K003” has made a comment (reply) “Good price!”.

Note that the comment database 22 may have any configuration as long as a person who posted a comment, the content of the comment, the item on which the comment was made, the posted date and time, and whether the item was purchased or not can be specified.

Referring back to FIG. 2, the receiving unit 11 is a means of receiving a user ID that identifies a user (viewer, or terminal user) who views a web page from the web server W. In this embodiment, at the time of displaying a web page in which a banner advertisement is embedded on the user terminal T, the user terminal T transmits a request for the web page to the web server W. In this request, a user ID of a viewer (terminal user) is embedded by a mechanism like Cookie. The web server W generates an advertisement request containing the user ID and transmits it to the advertisement server 10. The receiving unit 11 extracts the user ID from the advertisement request and outputs it to the associate extraction unit 12. The user ID of a viewer is referred to hereinafter as “viewer ID”.

The associate extraction unit 12 is a means of specifying a user (associate user) in a specified human relationship with a viewer by using the input viewer ID. In this embodiment, the viewer ID is equivalent of a reference user ID.

First, the associate extraction unit 12 extracts a friend ID corresponding to the viewer ID from the user relationship database 21. A user ID indicating a user who is in a friend relationship with the viewer is thereby obtained. Next, the associate extraction unit 12 performs the following process for each of one or more extracted friend IDs.

The associate extraction unit 12 extracts the comment data where the user ID matches the friend ID and the purchase flag is “yes” from the comment database 22 and thereby acquires the item ID indicating the item purchased by a friend of the viewer. Note that, at this time, the associate extraction unit 12 may simply extract the comment data where the user ID matches the friend ID. In other words, the associate extraction unit 12 may acquire the item ID indicating the item which a friend of the viewer has got interested in, regardless of whether the friend has purchased the item or not.

In the case where one or more item IDs can be acquired by the above process, the associate extraction unit 12 performs the following process for each of the acquired item IDs.

Specifically, the associate extraction unit 12 extracts the comment data which corresponds to the item ID and where the user ID is different from the viewer ID from the comment database 22 and thereby specifies the user IDs of other persons (anyone else for the viewer; comment users) who have made commends on the item purchased by the friend of the viewer. The associate extraction unit 12 then refers to the user relationship database 21 using the specified user IDs and the viewer ID and thereby selects a specified number of users sequentially in ascending order of the number of hops from the viewer and then stores the user IDs of the selected users as associate user IDs. This means that the user ID of a person who is in a close relationship with the viewer (for example, a friend or “a friend of a friend” etc.) is stored as the associate user ID. Note that the number of selected users may be set arbitrarily (for example, 2, 3 etc.). Then, the associate extraction unit 12 generates user group data composed of the item ID and the one or more associate user IDs stored.

The associate extraction unit 12 generates the user group data for each item of each friend and outputs one or more generated user group data to the comment extraction unit 13.

On the other hand, in the case where the item ID indicating the item purchased by a friend of the viewer cannot be acquired, the associate extraction unit 12 performs the above process, widening the search range of item purchase users along the social graph, until the item ID can be acquired. To be specific, the associate extraction unit 12 tries to acquire the item ID indicating the item purchased by “a friend of a friend” of the viewer. The social graph is a graph that represents friend relationships indicated by relationship data by links between nodes, which are used to resemble users. In this case, the distance between users can be represented in units of hops, and “a friend” is a relationship of one hop, “a friend of a friend” is a relationship of two hops. Widening the search range means increasing the number of hops for search. Note that the degree of widening the search range may be set arbitrarily. When the item ID is acquired by such a re-search process, the associate extraction unit 12 extracts the comment user as described above and generates the user group data.

The comment extraction unit 13 is a means of extracting the comment data corresponding to the associate user ID extracted by the associate extraction unit 12 from the comment database 22. The comment extraction unit 13 performs the following process for each of the input user group data.

First, the comment extraction unit 13 extracts the comment data which has the item ID contained in the user group data and where the user ID matches any of one or more associate user IDs contained in the user group data from the comment database 22. Then, the comment extraction unit 13 generates item comment data containing the item ID and the one or more extracted comment data.

The comment extraction unit 13 outputs one or more generated item comment data to the material extraction unit 14.

The material extraction unit 14 is a means of extracting advertisement material data of the item corresponding to each of the one or more input item comment data from the material database 15.

The advertisement material data is data indicating a material of an advertisement for an item and contains an item ID and material data indicating various kinds of materials to be displayed on a banner advertisement. The material indicated by the material data may be item-related information such as an item name and an item image, a background image and the like, though the variety of the material is not particularly limited. For example, any still image or video may be used as a material, or only text may be used as a material without using an image. As a matter of course, both of an image and text can be used as a material.

The material extraction unit 14 extracts the advertisement material data corresponding to the item ID contained in the item comment data from the material database 15 and stores the item comment data and the advertisement material data as one set. The material extraction unit 14 then outputs one or more sets obtained in this manner to the generation unit 16.

The generation unit 16 is a means of generating a banner advertisement (advertisement content) based on the input set (the item comment data and the advertisement material data). The generation unit 16 generates a banner advertisement using the material of an advertisement for the item indicated by the advertisement material data and the comment indicated by the comment data for each set, which is, for each item. In the banner advertisement, an item URL indicated by the comment data is embedded as a link.

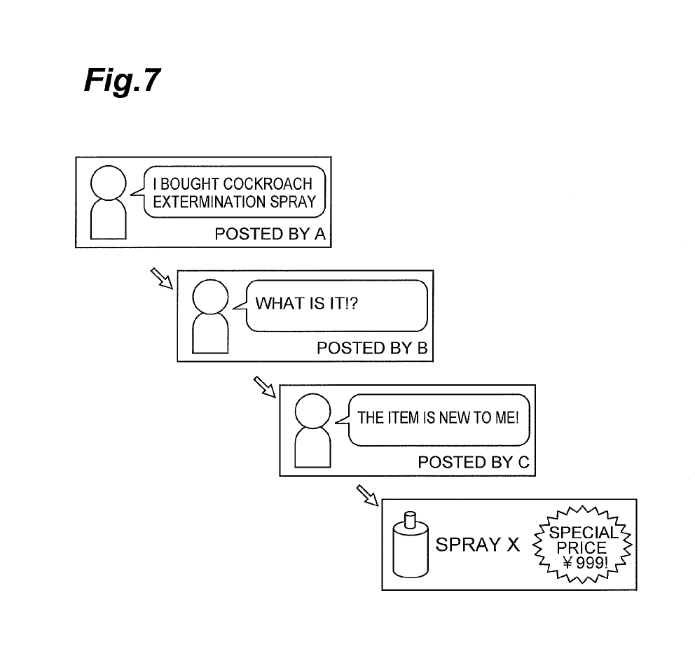

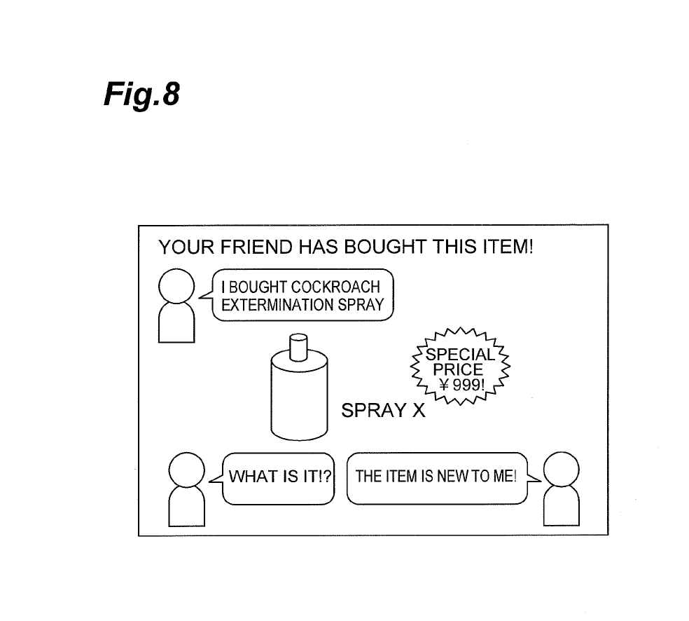

FIGS. 7 and 8 show examples of a banner advertisement. FIG. 7 is an example of a banner advertisement created by arranging comments of users indicated by comment data in chronological order (in ascending order of posted date and time) and generating four flame images and then displaying those images by switching between them every predetermined time (for example, every one second). In this manner, by displaying comments in order of registration, which is, in chronological order, it is possible to give a visual effect as if a conversation is made to the viewer of the web page and thereby effectively attract the interest of the user (consumer).

In the banner advertisement in FIG. 7, comments of users are displayed in the first to third frames, and information (item image, item name, price etc.) about the item is displayed in the fourth (last) flame. The generation unit 16 generates the first to third frames using the comments indicated by the item comment data or the like and generates the fourth flame using the material indicated by the advertisement material data or the like. Note that the generation unit 16 may apply various display effects such as adding animation effects to each frame or smoothly switching between the frames to the banner advertisement.

FIG. 8 is an example of a banner advertisement that looks like one poster. The generation unit 16 generates the banner advertisement using the comments indicated by the item comment data, the material indicated by the advertisement material data and the like. In this case also, the generation unit 16 may apply various display effects such as displaying comments in a specified order or adding animation effects to item images to the banner advertisement.

Note that the way a banner advertisement is constructed is not limited to the examples of FIGS. 7 and 8, and it may be constructed in any way. For example, the order of displaying comments is not limited to the order of registration and it may be in any order, and an item image may be displayed first and then comments may be displayed after that.

The generation unit 16 outputs data of one or more generated banner advertisements to the transmitting unit 17.

The transmitting unit 17 is a means of transmitting the input data of one or more input banner advertisements to the web server W as a response to the advertisement request in order to display the banner advertisement on the web page. The web server W receives the banner advertisement and transmits the banner advertisement together with the requested web page to the user terminal T. The banner advertisement is thereby displayed embedded in the web page in the user terminal T. In the case where a plurality of banner advertisements are generated and transmitted, those banner advertisements are displayed alternately by switching between one another at a specified position on the web page. This means that a plurality of advertisements for a plurality of items are displayed alternately by switching between them.

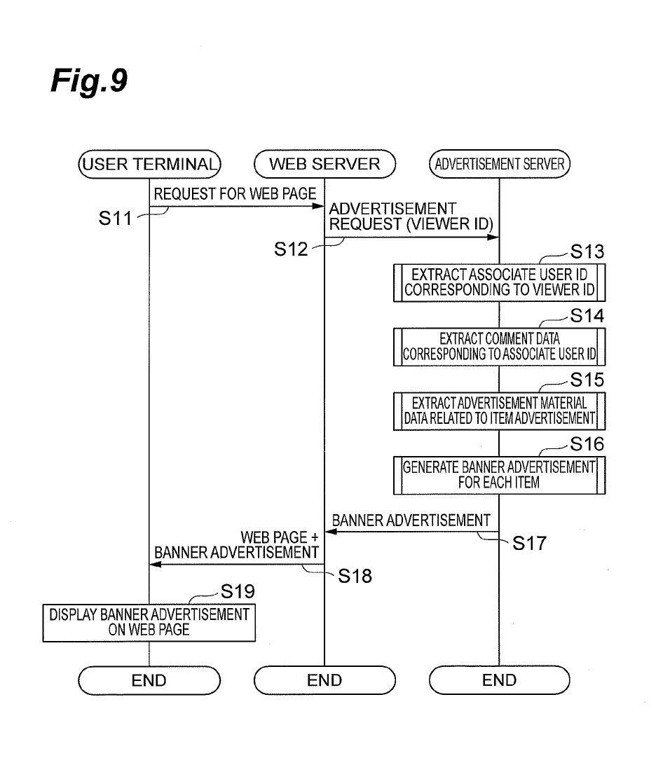

Hereinafter, the operation of the system (particularly, the advertisement server 10) shown in FIG. 1 is described and further an advertisement display method according to this embodiment is described with reference to FIGS. 9 to 13.

A series of processing steps from when a request for a web page is made by the user terminal T to when a web page with a banner advertisement is displayed on the terminal is as shown in FIG. 9. Specifically, when the user terminal T that displays a given web page makes a request for a web page (Step S11), the web server W receives the request and transmits an advertisement request containing a viewer ID to the advertisement server 10 (Step S12).

In the advertisement server 10, the receiving unit 11 receives the advertisement request (viewer ID) (Step S12). Then, the associate extraction unit 12 extracts the associate user ID corresponding to the viewer ID in order to specify a user in a specified human relationship with the viewer (Step S13, associate extraction step). Then, the comment extraction unit 13 extracts the comment data corresponding to the extracted associate user ID (Step S14, comment extraction step). Then, the material extraction unit 14 extracts the advertisement material data corresponding to an item advertisement (Step S15). Then, the generation unit 16 generates a banner advertisement for each item by using the extracted comment data and the advertisement material data (Step S16, generation step). Then, the transmitting unit 17 transmits data of the banner advertisement to the web server W (Step S17, output step).

After that, the web server W receives the data of the banner advertisement and transmits the banner advertisement together with the web page to the user terminal T (Step S18), and the user terminal T displays the banner advertisement, embedded in the web page (Step S19).

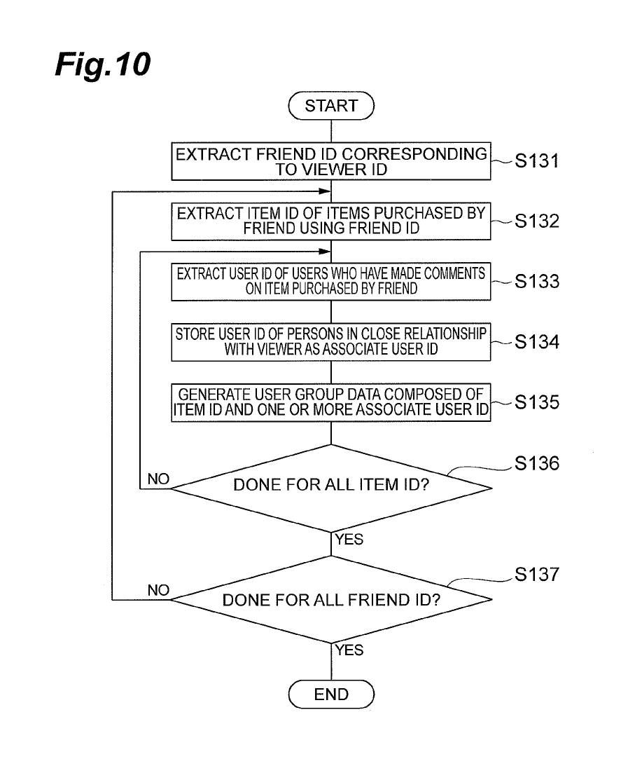

The operation of the associate extraction unit 12 (Step S13) is described in detail with reference to FIG. 10. The associate extraction unit 12 extracts the friend IDs corresponding to the input viewer ID from the user relationship database 21 (S131). The associate extraction unit 12 then searches the comment database 22 using one friend ID (one friend ID specified from the friend IDs extracted in Step S131) and extracts the item IDs of items purchased by the friend specified by the friend ID (Step S132). Then, the associate extraction unit 12 searches the comment database 22 using one item ID (one item ID specified from the item IDs extracted in Step S132) and extracts the user IDs of users who have made comments on the item specified by the item ID (Step S133). Then, the associate extraction unit 12 refers to the user relationship database 21 and stores the user IDs of persons in a close relationship with the viewer as associate user IDs (Step S134) and generates user group data composed of the item ID and one or more associate user IDs (Step S135).

Note that, in place of the above-described steps S133 and S134, the associate extraction unit 12 may acquire associate user IDs by retrieving users who have made comments on the item purchased by a friend sequentially in ascending order of the number of hops from the viewer.

The associate extraction unit 12 performs the processing of the above-described Steps S133 to S135 for each of all the extracted item IDs, for one friend ID (cf. Step S136). Further, the associate extraction unit 12 performs the processing of the above-described Steps S132 to S136 for each of all the extracted friend IDs (Step S137).

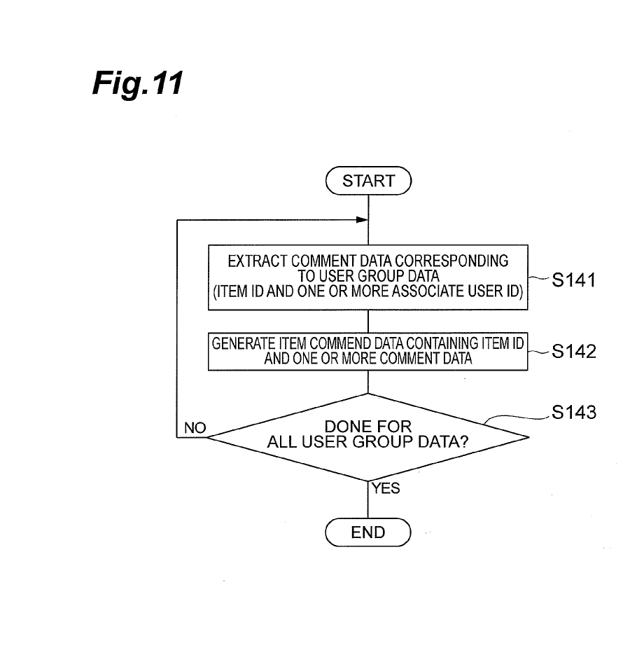

The detail of the operation of the comment extraction unit 13 (Step S14) is as shown in FIG. 11. Specifically, the comment extraction unit 13 extracts the comment data corresponding to one user group data (the item ID and one or more associate user IDs) from the comment database 22 (Step S141). Then, the comment extraction unit 13 generates item comment data that contains the item ID and one or more extracted comment data (Step S142). The comment extraction unit 13 performs this processing for each of all the user group data (cf. Step S143).

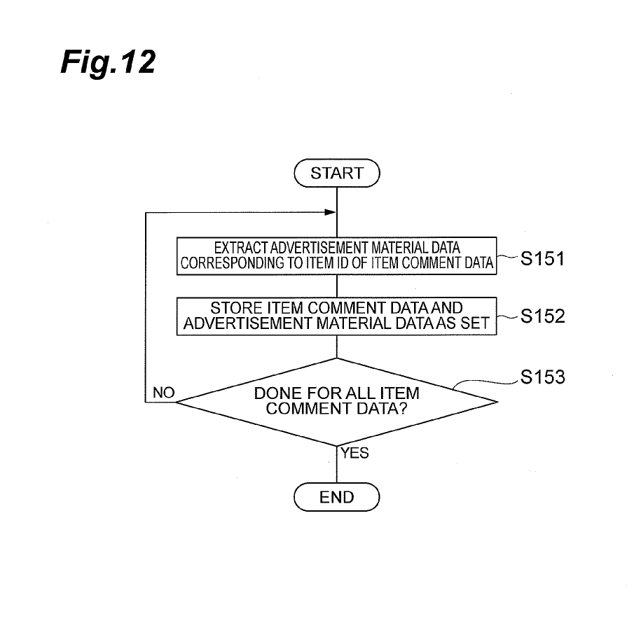

The detail of the operation of the material extraction unit 14 (Step S15) is as shown in FIG. 12. Specifically, the material extraction unit 14 extracts the advertisement material data corresponding to the item ID of one item comment data from the material database 15 (Step S151). Then, the material extraction unit 14 stores the item comment data and the extracted advertisement material data as a set (Step S152). The material extraction unit 14 performs this processing for each of all the item comment data (cf. Step S153) and finally outputs all sets to the generation unit 16.

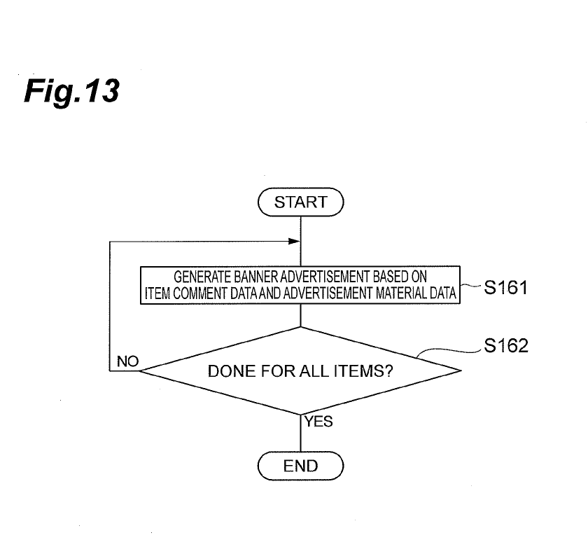

The detail of the operation of the generation unit 16 (Step S16) is as shown in FIG. 13. Specifically, the generation unit 16 generates a banner advertisement based on one set (the item comment data and the advertisement material data) (Step S161). The generation unit 16 performs this processing for each of all the sets (items) (cf. Step S162).

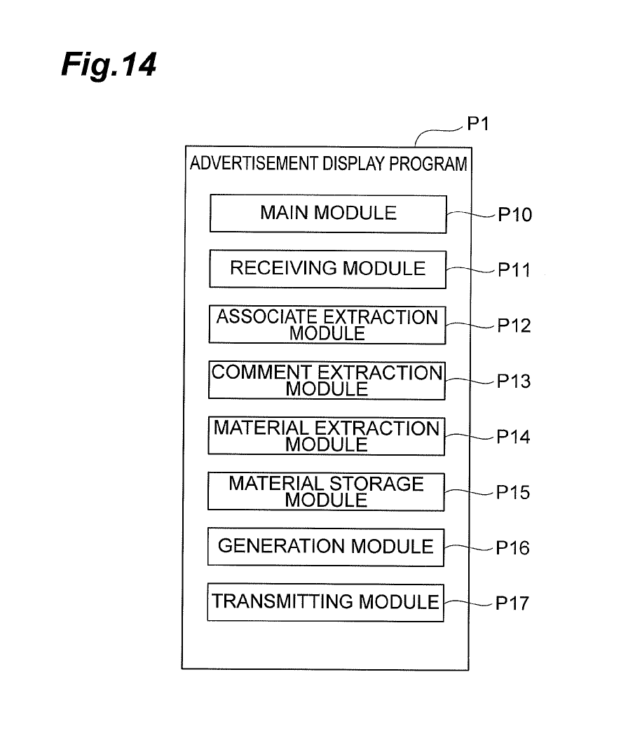

An advertisement display program P1 that causes a computer to function as the advertisement server 10 is described hereinafter with reference to FIG. 14.

The advertisement display program P1 includes a main module P10, a receiving module P11, an associate extraction module P12, a comment extraction module P13, a material extraction module P14, a material storage module P15, a generation module P16, and a transmitting module P17.

The main module P10 is a part that exercises control over the advertisement display function. The functions implemented by the receiving module P11, the associate extraction module P12, the comment extraction module P13, the material extraction module P14, the material storage module P15, the generation module P16 and the transmitting module P17 are respectively the same as the functions of the receiving unit 11, the associate extraction unit 12, the comment extraction unit 13, the material extraction unit 14, the material database 15, the generation unit 16 and the transmitting unit 17.

The advertisement display program P1 is provided in the form of being recorded in a static manner on a recording medium such as CD-ROM, DVD-ROM or semiconductor memory, for example. Further, the advertisement display program P1 may be provided as a data signal superimposed onto a carrier wave through a communication network.

As described above, according to this embodiment, an associate user who is in a specified human relationship with a viewer is specified, and a comment on an item by the associate user is extracted. Then, an image of an item advertisement where the comment is displayed is generated and finally displayed on a web page which the viewer intends to view. In this manner, by displaying an item advertisement including a comment of a person who is in some kind of relationship with a viewer, the viewer can see the comment as being familiar. As a result, it is possible to effectively attract the interest of a user (consumer).

Particularly in this embodiment, users who have made comments on an item on which a friend of a viewer has made a comment are specified as comment users, and a specified number of users who are in a close relationship with the viewer among the comment users are extracted. Consequently, comments on the item which the friend of the viewer has got interested in by users who are in a close relationship with the viewer are displayed as a part of a banner advertisement. As a result, the viewer can see the comments as being familiar, and it is thereby possible to let the viewer (consumer) have a further interest in the item.

### Second Embodiment

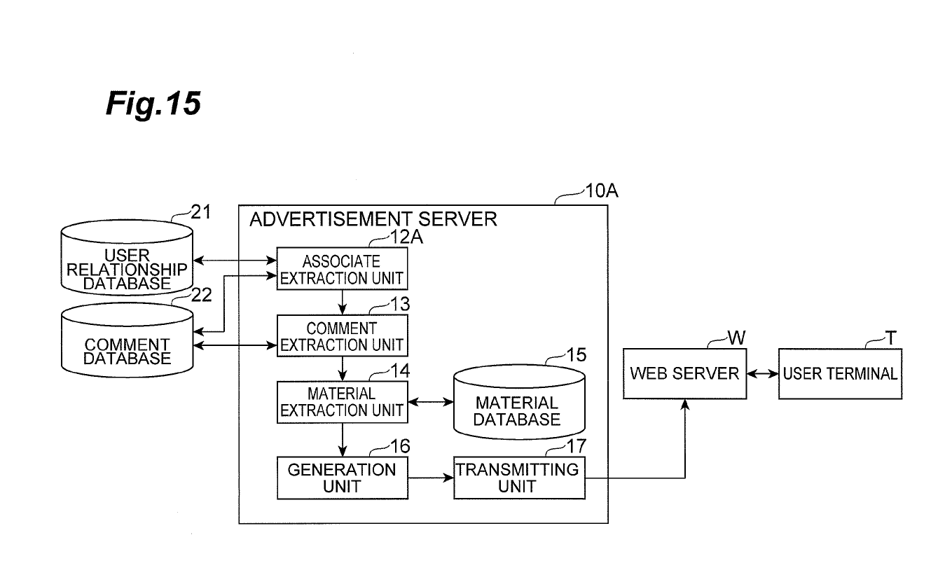

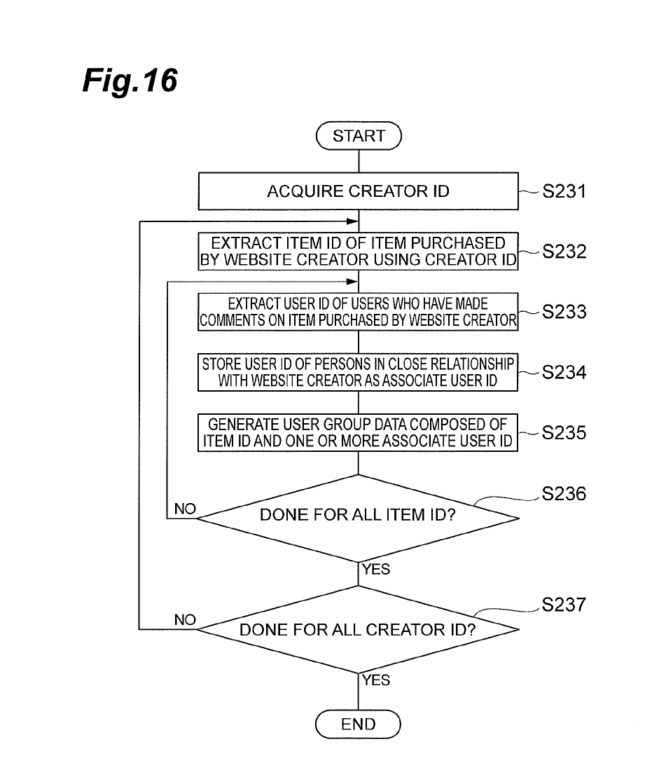

An advertisement server 10A according to a second embodiment is described hereinafter with reference to FIGS. 15 and 16. The advertisement server 10A is different from the advertisement server 10 according to the first embodiment in that it extracts associate users based on a creator who set up a personal page such as a blog (which is referred to hereinafter as a website creator), rather than extracting associate users based on a viewer. Further, the advertisement server 10A is also different from the advertisement server 10 in that it generates a banner advertisement by batch processing, not by a request from the web server W. Hereinafter, the same or equivalent function and configuration as those in the first embodiment are not redundantly described.

As shown in FIG. 15, the advertisement server 10A includes an associate extraction unit 12A, a comment extraction unit 13, a material extraction unit 14, a material database 15, a generation unit 16, and a transmitting unit 17 as functional components. The associate extraction unit 12A, which is different from that in the first embodiment, is particularly described hereinbelow.

The associate extraction unit 12A is a means of specifying a user (associate user) in a specified human relationship with a website creator by using the user ID of the website creator. The user ID of a website creator is referred to hereinafter as a creator ID. In this embodiment, the creator ID is equivalent of a reference user ID.

The operation of the associate extraction unit 12A is described with reference to FIG. 16. When it becomes the start time for batch processing, the associate extraction unit 12A first acquires a creator ID (Step S231). The associate extraction unit 12A may acquire the creator ID by a method that actively reads the ID from a specified database, a method that receives the ID as an argument from a batch processing program or the like, though the method of acquisition is not limited thereto. When the associate extraction unit 12A acquires one or more creator IDs, it performs the following processing for each of the creator IDs.

First, the associate extraction unit 12A extracts the comment data where the user ID matches the creator ID and the purchase flag is “yes” from the comment database 22 and thereby acquires the item ID indicating the item purchased by the website creator (Step S232). Note that, at this time, the associate extraction unit 12A may simply extract the comment data where the user ID matches the creator ID. In other words, the associate extraction unit 12A may acquire the item ID indicating the item which the website creator has got interested in, regardless of whether the website creator has purchased the item or not.

In the case where one or more item IDs can be acquired by the above processing, the associate extraction unit 12A performs the following process for each of the acquired item IDs.

Specifically, the associate extraction unit 12A extracts the comment data which corresponds to the item ID and where the user ID is different from the creator ID from the comment database 22 and thereby specifies the user IDs of other persons (comment users) who have made commends on the item purchased by the website creator (Step S233). The associate extraction unit 12A then refers to the user relationship database 21 using the specified user IDs and the creator ID and thereby selects a specified number of users sequentially in ascending order of the number of hops from the website creator and then stores the user IDs of the selected users as associate user IDs (Step S234). This means that the user ID of a person who is in a close relationship with the website creator is stored as the associate user ID. Note that the number of selected users may be set arbitrarily. Then, the associate extraction unit 12A generates user group data composed of the item ID and the one or more associate user IDs stored (Step S235).

Note that, in place of the above-described steps S233 and S234, the associate extraction unit 12 may acquire associate user IDs by retrieving users who have made comments on the item purchased by the website creator sequentially in ascending order of the number of hops from the website creator.

The associate extraction unit 12A generates the user group data for each item of each website creator (cf. Steps S236, S237) and outputs one or more generated user group data to the comment extraction unit 13.

After the user group data is generated, the comment extraction unit 13, the material extraction unit 14 and the generation unit 16 perform the same processing as described in the first embodiment, and finally the transmitting unit 17 transmits data of one or more banner advertisements to the web server W. In this embodiment, the web server W receives the data of banner advertisements and stores the data into a specified database. Therefore, when a user accesses a personal page of the website creator, the banner advertisement generated for the website creator is displayed embedded in the personal page.

In this embodiment also, the same advantageous effects as in the first embodiment can be obtained. To be specific, users who have made comments on an item on which a website creator has made a comment are specified as comment users, and a specified number of users who are in a close relationship with the website creator among the comment users are extracted. Consequently, comments by users who are in a close relationship with the website creator are displayed as a part of a banner advertisement. As a result, the viewer can see the comments on the banner advertisement as being familiar, and it is thereby possible to let the viewer (consumer) have a further interest in the item.

### Third Embodiment

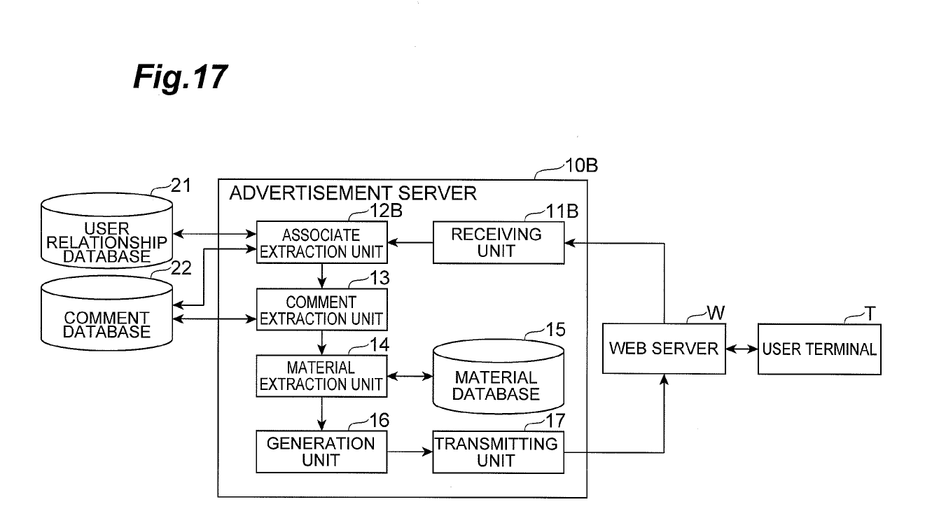

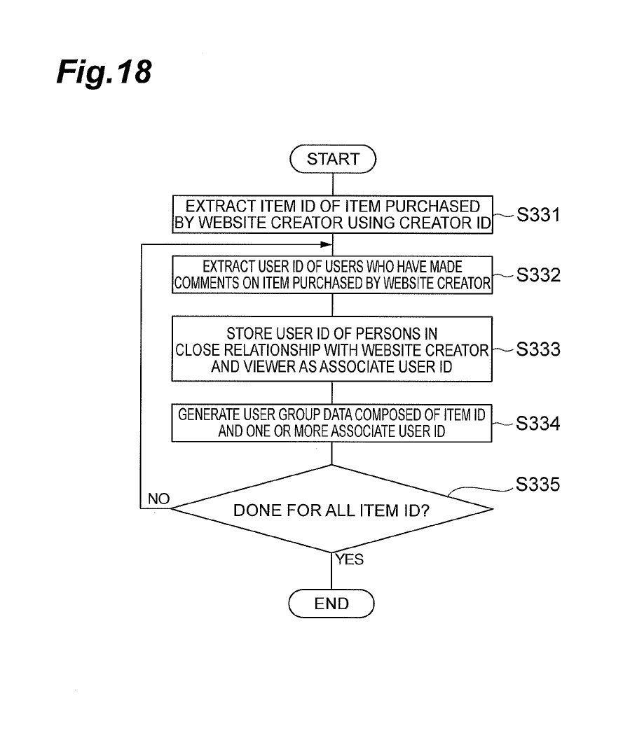

An advertisement server 10B according to a third embodiment is described hereinafter with reference to FIGS. 17 and 18. The advertisement server 10B is different from the advertisement server 10A according to the second embodiment in that it extracts users who are in a close relationship with not only a creator who set up a personal page but also a viewer of the personal page as associate users. Further, the advertisement server 10B is also different from the advertisement server 10A in that it generates a banner advertisement based on a request from the web server W. Hereinafter, the same or equivalent function and configuration as those in the second embodiment are not redundantly described.

As shown in FIG. 17, the advertisement server 10A includes a receiving unit 11B, an associate extraction unit 12B, a comment extraction unit 13, a material extraction unit 14, a material database 15, a generation unit 16, and a transmitting unit 17 as functional components. The receiving unit 11B and the associate extraction unit 12B, which are different from those in the second embodiment, are particularly described hereinbelow.

The receiving unit 11B is a means of receiving a creator ID and a viewer ID from the web server W. In this embodiment, at the time of displaying a personal page on the user terminal T, the user terminal T makes a request for the personal page to the web server W. In this request, a viewer ID is embedded by a mechanism like Cookie. The web server W generates an advertisement request containing the viewer ID and the creator ID corresponding to the personal page read from a specified database and transmits it to the advertisement server 10. The receiving unit 11B extracts two kinds of user IDs from the advertisement request and outputs them to the associate extraction unit 12B.

The associate extraction unit 12B is a means of specifying a user (associate user) in a specified human relationship with a website creator and a viewer by using the input creator ID and the viewer ID.

The operation of the associate extraction unit 12B is described hereinafter with reference to FIG. 18. First, the associate extraction unit 12B extracts the comment data where the user ID matches the creator ID and the purchase flag is “yes” from the comment database 22 and thereby acquires the item ID indicating the item purchased by the website creator (Step S331). Note that, at this time, the associate extraction unit 12B may simply extract the comment data where the user ID matches the creator ID. In other words, the associate extraction unit 12B may acquire the item ID indicating the item which the website creator has got interested in, regardless of whether the website creator has purchased the item or not.

In the case where one or more item IDs can be acquired by the above processing, the associate extraction unit 12B performs the following process for each of the acquired item IDs.

Specifically, the associate extraction unit 12B extracts the comment data which corresponds to the item ID and where the user ID is different from any of the creator ID and the viewer ID from the comment database 22 and thereby specifies the user IDs of other persons (comment users) who have made commends on the item purchased by the website creator (Step S332). The associate extraction unit 12B then refers to the user relationship database 21 using the specified user IDs, the creator ID and the viewer ID and thereby selects a specified number of users sequentially in ascending order of the number of hops from both of the website creator and the viewer and then stores the user IDs of the selected users as associate user IDs (Step S333). This means that the user ID of a person who is in a close relationship with the website creator and the viewer is stored as the associate user ID. Note that the number of selected users may be set arbitrarily.

Selecting comment users sequentially in ascending order of the number of hops from both of the website creator and the viewer means selecting comment users sequentially in ascending order of the sum of the number of hops from the website creator and the number of hops from the viewer. The minimum value of the sum is two, which indicates a common friend of the website creator and the viewer, and thus the associate extraction unit 12B preferentially selects the common friend. In some cases, the associate extraction unit 12B selects a comment user where the minimum value of the sum is three (who is a friend for one of the website creator and the viewer and “a friend of a friend” for the other one). Further, there can be a case where the associate extraction unit 12B selects a comment user where the minimum value of the sum is four. The user where the minimum value of the sum is four is a person who is “a friend of a friend” for both of the website creator and the viewer or who is a friend for one of them and in a relationship of three hops away for the other one.

After selecting associate users in this manner, the associate extraction unit 12B generates user group data composed of the item ID and the one or more associate user IDs stored (Step S334).

Note that, in place of the above-described steps S332 and S333, the associate extraction unit 12 may acquire associate user IDs by retrieving users who have made comments on the item purchased by the website creator sequentially in ascending order of the number of hops from the website creator and the viewer.

The associate extraction unit 12B generates the user group data for each item (cf. Step S335) and outputs one or more generated user group data to the comment extraction unit 13.

After the user group data is generated, the comment extraction unit 13, the material extraction unit 14 and the generation unit 16 perform the same processing as described in the second embodiment, and finally the transmitting unit 17 transmits data of one or more banner advertisements to the web server W. The web server W receives the banner advertisement and transmits the banner advertisement together with the personal page to the user terminal T. The banner advertisement is thereby displayed embedded in the personal page on the user terminal T. In the case where a plurality of banner advertisements for a plurality of items are generated and transmitted, those banner advertisements are displayed alternately by switching between one another at a specified position on the personal page.

In this embodiment also, the same advantageous effects as in the first and second embodiments can be obtained. To be specific, users who have made comments on an item on which a website creator has made a comment are specified as comment users, and a specified number of users who are in a close relationship with both the creator and the viewer among the comment users are extracted. Consequently, comments on the item which the website creator has got interested in by users who are in a close relationship with the website creator and the viewer are displayed as a part of a banner advertisement. As a result, the viewer can see the comments on the banner advertisement as being familiar, and it is thereby possible to let the viewer (consumer) have a further interest in the item.

Hereinbefore, the present invention has been described in detail with respect to the embodiment thereof. However, the present invention is not limited to the above-described embodiment. Various changes and modifications may be made therein without departing from the scope of the invention.

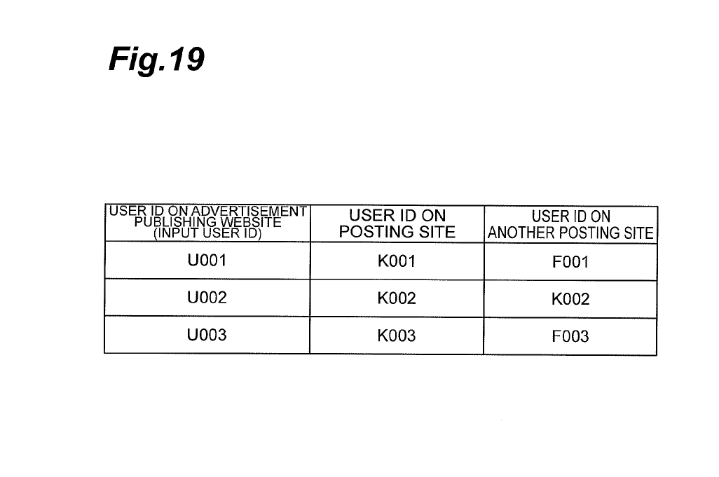

Each of the above embodiments is described based on the assumption that the user ID managed in the advertisement publishing website (the web server W and the advertisement server 10) and the user ID managed in the external database (the user relationship database 21 and the comment database 22) are the same. However, there are many cases where those user IDs are different from each other, that is, where a user ID indicating one user is different from system to system. In such a case, the associate extraction means refers to a translation table as shown in FIG. 19 and acquires a user ID for searching the user relationship database 21 which corresponds to the input user ID. Using the acquired user ID, the associate extraction means then acquires a friend ID from the user relationship database 21.

The translation table is a correspondence table of user ID between systems. Data in the translation table is generated by exchanging tokens in OAuth, which is a mechanism related to transfer of authorization information, between services. The place where the translation table resides is not limited, and it may be placed in the advertisement server 10, 10A, 10B or the posting server C, for example, or placed in another server not shown in FIG. 1. In the example of FIG. 19, the data in the first row shows that the user specified by the user ID “U001” in an advertisement publishing website is registered with the user ID “K001” in a posting site managed by the posting server C and the user ID “F001” in another posting site. Note that, as shown in the data in the second row, there is also a case where the same user ID between sites is assigned. According to the example of FIG. 19, in the case where the user ID “U001” is input, the associate extraction means acquires the corresponding user ID “K001” from the translation table.

Placement of each server may be determined arbitrarily. Although the advertisement server 10 and the web server W are placed separately in each of the above embodiments, those servers may be integrated into one server. In this case, a request signal and a banner advertisement are directly transmitted and received between the user terminal T and the integration server. Describing this alternative example with reference to FIG. 9, the web server located at the middle is omitted, and accordingly, the processing steps S11 and S12 are integrated as one request processing, and the processing steps S17 and S18 are integrated as one response processing.

Furthermore, the advertisement server 10, 10A, 10B may be integrated with the posting server C or the online shopping server E.

Although a banner advertisement is generated using the advertisement material data extracted by the material extraction unit 14 in each of the above embodiments, whether or not to use the advertisement material data may be determined arbitrarily. Thus, the material extraction unit 14 and the material database 15 are not essential components.

Although a banner advertisement containing a still image or video is used as the advertisement content in each of the above embodiments, the form of the advertisement content is not particularly limited. For example, the advertisement display device may generate the advertisement content using text only without using images. Further, the advertisement display device may generate the advertisement content to be displayed in a display area (for example, a desktop area) other than a web page. In this manner, the advertisement display device may generate the advertisement content in any structure and form.

In each of the above embodiments, it is described that associate users may be extracted finally without referring to a purchase flag. With regard to this, the comment data with no purchase flag may be used, or such comment data and the comment data shown in FIG. 5, 6 may be used in combination. Further, the comment that is displayed in the advertisement content is not limited to text that is input through a keyboard, and it may be the comment corresponding to data that is input by a button such as “Like” or “Nice”, for example.

Although the advertisement server 10, 10A, 10B and the user terminal T are in the relationship of a server and a client in each of the above embodiments, the advertisement display device may be a single device. In this case, the advertisement display device further includes the function of directly accepting user input and the function of displaying advertisement content. In this case also, the advertisement display device generates advertisement content by communicating with the user relationship database 21 and the comment database 22 through a given communication network and displays the content.

### REFERENCE SIGNS LIST

10,10A,10B . . . advertisement server (advertisement server), 11,11B . . . receiving unit, 12,12A,12B . . . associate extraction unit (associate extraction means), 13 . . . comment extraction unit (comment extraction means), 14 . . . material extraction unit, 15 . . . material database, 16 . . . generation unit (generation means), 17 . . . transmitting unit (output means), 21 . . . user relationship database, 22 . . . comment database, C . . . posting server, E . . . online shopping server, P1 . . . advertisement display program, P10 . . . main module, P11 . . . receiving module, P12 . . . associate extraction module, P13 . . . comment extraction module, P14 . . . material extraction module, P15 . . . material storage module, P16 . . . generation module, P17 . . . transmitting module, T . . . user terminal, W . . . web server

1-9. (canceled)

10. An advertisement display device comprising:
an associate extraction unit for, in order to specify an associate user in a specified human relationship with a reference user being a creator who set up a web page, extracting an associate user ID of the associate user corresponding to a reference user ID indicating the reference user from a user relationship database that stores relationship data indicating relationships between users;
a comment extraction unit for extracting comment data indicating a comment posted by an associate user indicated by the associate user ID extracted by the associate extraction unit from a comment database that stores comment data indicating comments on items by users;
a generation unit for generating advertisement content of an item indicated by the comment data extracted by the comment extraction unit, the advertisement content displaying a comment indicated by the comment data; and
an output unit for outputting the advertisement content generated by the generation unit so that the advertisement content is displayed on the web page set up by the reference user.

11. The advertisement display device according to claim 10, wherein
the associate extraction unit extracts the associate user ID of the associate user in a specified relationship with the reference user and a viewer of the web page.

12. The advertisement display device according to claim 10, wherein
the associate extraction unit specifies an item on which a comment has been made by the creator by referring to the user relationship database, and extracts the associate user ID of the associate user who has made an comment on the item.

13. The advertisement display device according to claim 12, wherein
the comment extraction unit extracts comment data indicating a comment on the item posted by one of the reference user and the associate user and comment data indicating a comment made by another one of the users in response to that comment, and
the generation unit generates the advertisement content to display the comment posted by the reference user and the comment posted by the associate user.

14. The advertisement display device according to claim 10, wherein,
when there are a plurality of comments to be displayed by the advertisement content, the generation unit generates the advertisement content so that the comments are displayed in order of registration of the comments.

15. The advertisement display device according to claim 10, wherein
the generation unit generates the advertisement content as a banner advertisement where URL of a web page on which the item appears is embedded as a link.

16. The advertisement display device according to claim 10, wherein
the associate extraction unit extracts user IDs of a specified number of users extracted based on the number of hops from the reference user as the associate user ID.

17. An advertisement display method executed by an advertisement display device, the method comprising:
an associate extraction step of, in order to specify an associate user in a specified human relationship with a reference user being a creator who set up a web page, extracting an associate user ID of the associate user corresponding to a reference user ID indicating the reference user from a user relationship database that stores relationship data indicating relationships between users;
a comment extraction step of extracting comment data indicating a comment posted by an associate user indicated by the associate user ID extracted in the associate extraction step from a comment database that stores comment data indicating comments on items by users;
a generation step of generating advertisement content of an item indicated by the comment data extracted in the comment extraction step, the advertisement content displaying a comment indicated by the comment data; and
an output step of outputting the advertisement content generated in the generation step so that the advertisement content is displayed on the web page set up by the reference user.
